(19) United States
(12) Patent Application Publication
(10) Pub. No.: US 2007/0046006 A1
(43) Pub. Date: Mar. 1, 2007

(54) Gas generator

(75) Inventors: Nobuyuki Katsuda, Tatsuno-Shi (JP); Mikio Yabuta, Tatsuno-Shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/503,914

(22) Filed: Aug. 15, 2006

Related U.S. Application Data
(60) Provisional application No. 60/712,849, filed on Sep. 1, 2005.

(30) Foreign Application Priority Data
Aug. 29, 2005 (JP) 2005-247914

(51) Int. Cl. B60R 21/26; B60R 21/217

(52) U.S. Cl. 280/740; 280/728.2; 280/742; 280/736

(57) ABSTRACT

The present invention provides gas generator including a module case forming a housing having a gas discharge port and including a combustion chamber therein, the combustion chamber accommodating an igniter and a gas generating agent inside a combustion chamber housing, an opening, for discharging gas, being generated in the combustion chamber housing when the gas generating agent is ignited and burnt to generate gas by activation of the igniter.

This nonprovisional application claims priority under 35 U.S.C. § 119(a) on Patent Application No. 2005-247914 filed in Japan on 29 Aug. 2005, and 35 U.S.C. § 119(e) on U.S. Provisional Application No. 60/712,849 filed on 1 Sep. 2005, which are incorporate by reference.

### BACKGROUND OF THE INVENTION

1. Field of the Invention

The present invention relates to a gas generator used in an air bag system of an automobile.

2. Description of Related Art

A gas generator used in an air bag system of an automobile needs to be reduced in weight and size in order to be disposed in the limited space of the vehicle interior, and needs to be further reduced in thickness when attached to the ceiling surface, side surface, and so on of the automobile.

WO 99/38725 A3 may be cited as prior art relating to the present invention.

### SUMMARY OF THE INVENTION

The present invention provides a gas generator, comprising a module case forming a housing having a gas discharge port and a combustion chamber included in the module, the combustion chamber accommodating an igniter and a gas generating agent inside a combustion chamber housing, an opening being generated in the combustion chamber housing to discharge gas when the gas generating agent is ignited and burnt to generate gas by activation of the igniter.

In other words, the present invention provides a gas generator in which a housing having a gas discharge port is formed by a module case, and a combustion chamber is provided in the module case, wherein an igniter and a gas generating agent are accommodated within a combustion chamber housing of the combustion chamber, and when the gas generating agent is ignited and burned upon activation of the igniter such that a gas is generated, an opening is created in the combustion chamber housing through which the gas is discharged.

### BRIEF DESCRIPTION OF THE DRAWINGS

The present invention will become more fully understood from the detailed description given hereinbelow and the accompanying drawings which are given by way of illustration only, and thus are not limitative of the present invention and wherein;

FIG. 1 shows a perspective view of a gas generator;

FIG. 2 shows a perspective view of a combustion chamber;

FIG. 3(a) shows an end face view of the combustion chamber shown in FIG. 2, FIG. 3(b) shows a vertical sectional view in a short axis direction, and FIG. 3(c) shows a vertical sectional view in a long axis direction; and

FIG. 4 shows an illustrative view of an assembly method for the gas generator.

### DETAILED DESCRIPTION OF THE INVENTION

The present invention provides a gas generator in which the number of components can be reduced, and which can be disposed in a narrower space within a vehicle interior.

In the present invention, the module case also functions as the housing of the gas generator, and hence a pressure-resistant container serving as the housing is not required. Note that when the gas generator of the present invention is combined with an air bag and disposed in a vehicle, the gas generator is fixed by connecting a part of the module case to the vehicle main body, and attaching the air bag to the gas discharge ports in the module case. If necessary, a cover member may also be attached to protect the air bag.

The present invention further provides the gas generator, wherein a cross section of the combustion chamber housing and the module case in a width direction thereof is elliptical.

By making the cross section of the gas generator, cut along the width direction thereof, elliptical, the combined thickness of the gas generator and module case can be reduced in comparison with a case in which the cross section is circular.

The present invention further provides the gas generator, wherein the module case can be divided into two parts, and only one of the two divided parts has the gas discharge port.

By making the module case separable into two parts in the vertical direction (thickness direction), one of the separated parts can be attached to the vehicle main body, then the combustion chamber can be attached, and then the other separated part can be attached, for example, and hence an improvement in workability can be achieved.

In the gas generator of the present invention, the housing is formed by a module case, and therefore the number of components can be reduced and the overall thickness can be reduced, leading to a reduction in volume.

### Embodiment of the Invention

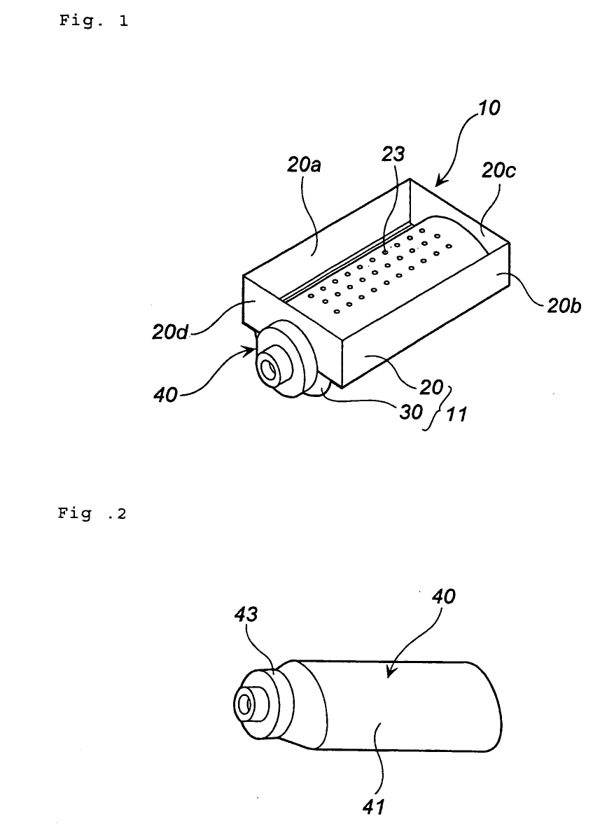

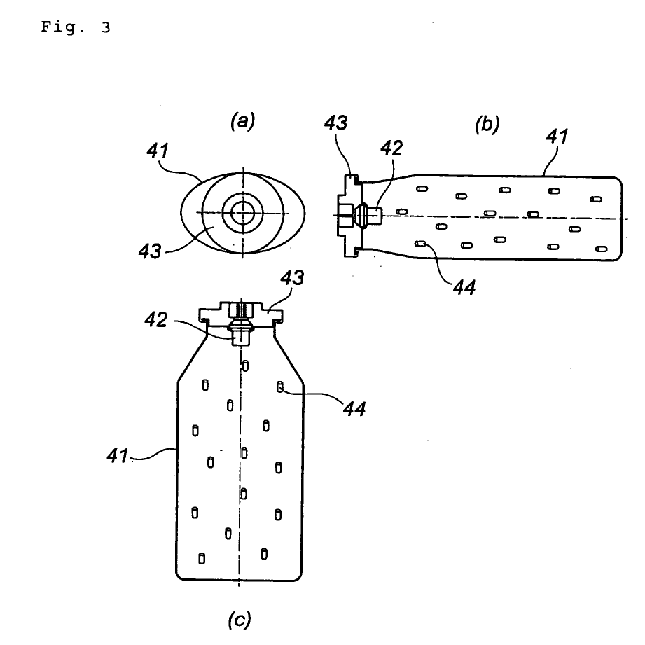

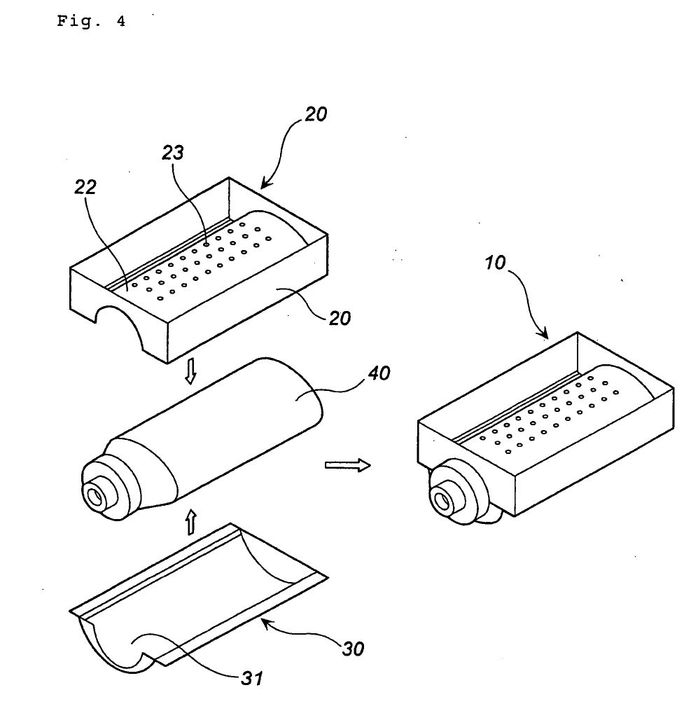

An embodiment of the present invention will be described with reference to FIGS. 1 to 4. FIG. 1 is a perspective view of a gas generator, FIG. 2 is a perspective view of a combustion chamber of the gas generator, FIG. 3(a) is an end face view of the combustion chamber in an igniter side, FIG. 3(b) is a vertical sectional view in a short axis direction, FIG. 3(c) is a vertical sectional view in a long axis direction, and FIG. 4 is an illustrative view of an assembly method for the gas generator.

As shown in FIG. 1, in a gas generator 10, a combustion chamber 40 is surrounded by an upper portion module case 20 and a lower portion module case 30. A module case 11 is formed by a combination of the upper portion module case and the lower portion module case 30.

As shown in FIGS. 1 and 4, the upper portion module case 20 has a rectangular planar form, and is provided with a convex portion (a concave portion when seen from the rear surface side) 22 extending over the entire length direction and having a cross-section in the width direction thereof which takes the form of a half-ellipse. A plurality of gas discharge ports 23 are provided in the surface of the convex portion 22. The upper portion module case 20 is formed by plated sheet steel, aluminum, stainless steel, zinc, synthetic resin, or another material.

The plurality of gas discharge ports 23 may be covered from the inside or outside by a filter having filtering and cooling functions. There are no particular limitations on the shape of the filter, and a plate-form, cylindrical, or other filter may be used.

The convex portion 22 is positioned in a space surrounded by side faces 20a, 20b, 20c, 20d of the upper portion module case 20. The width (long axis length) of the convex portion 22 is shorter than the width of the upper portion module case 20 (the length of the side face 20c or the side face 20d) and the height (half the length (½) of the short axis) of the convex portion 22 is lower than the height of the side faces 20a, 20b, 20c, 20d.

As shown in FIG. 4, the lower portion module case 30 has a rectangular form of identical dimensions to the upper portion module case 20, and is provided with a concave portion (a protruding portion when seen from the rear surface side) 31 extending over the entire length direction and having a cross-section in the width direction thereof which takes the form of a half-ellipse. The lower portion module case 30 is formed by aluminum, stainless steel, or another Material.

When the upper portion module case 20 and lower portion module case 30 are combined, the form and dimensions of the space formed by the convex portion 22 and concave portion 31 match the outer form and dimensions of the combustion chamber 40 (combustion chamber housing 41) shown in FIG. 2.

With respect to the combustion chamber 40, as shown in FIGS. 3(b) and 3(c), a required amount of a gas generating agent 44 is charged into the combustion chamber housing 41, which takes the form of a bottle having one open end. As is evident from FIG. 3(a), the sectional form of the combustion chamber housing 41 in the width direction thereof is elliptical.

An opening is formed in the combustion chamber housing 41 in activation of the gas generator 10, thereby forming a gas discharge path to the gas discharge ports 23 in order to discharge gas. The outside of the combustion chamber 40 is protected by the module case 11, and therefore the combustion chamber housing 41 does not need to be particularly pressure-resistant, a degree of pressure resistance enabling an igniter 42 and the gas generating agent 44 to be accommodated and held therein being sufficient.

As means for forming an opening in the combustion chamber housing 41 in activation of the gas generator 10, the following means may be used. The opening is preferably opened in a part of the combustion chamber housing 41 which faces the gas discharge ports 23.

(I) A method of forming an opening by providing a fragile portion, which is formed by partially reducing the thickness of the wall surface of the combustion chamber housing or by means of a notch or groove, so that the fragile portion is ruptured in activation. Note that a method of rupturing the combustion chamber housing without providing a fragile portion may also be used.

(II) A method of forming an opening by providing an opening portion in the combustion chamber housing and sealing the opening portion with a rupturable member such as an aluminum seal or a stainless steel seal, so that the rupturable member is ruptured in activation.

(III) A method of forming an opening by burning the combustion chamber housing or the rupturable member of method (II).

A boss 43 is fixed by welding to the opening portion a tone end of the combustion chamber housing 41, and the electric igniter 42 is fitted in and fixed to the boss 43. The electric igniter 42 is disposed directly opposite the charged gas generating agent 44. If necessary, a transfer charge (boron/niter, nitroguanidine, or the like) stored in a container may be disposed in a position in the vicinity of the electric igniter 42 inside the combustion chamber 40.

As shown in FIG. 4, when assembling the gas generator 10, the combustion chamber 40 is surrounded by the upper portion module case 20 and lower portion module case 30 so as to be sandwiched from above and below. However, at this time the boss 43 protrudes to the outside of the module case 11 so that a connector can be inserted into the igniter 42 fitted into the boss 43, and a lead wire can be connected to a power source (the battery of the automobile).

When disposing the gas generator 10 in the vehicle, the side faces 20a, 20b, 20c of the module case 11, the lower portion module case 30 or the like is fixed, in accordance to a direction of the air bag inflation, to the vehicle by using nuts, bolts, etc.

When disposing an air bag in the gas generator 10, a gas introduction port of the air bag is placed over and connected to the side faces 20a, 20b, 20c, 20d, whereupon the air bag is folded and stored in the space surrounded by the side faces 20a, 20b, 20c, 20d. Note that to protect the air bag, a cover member (having an air bag ejection port) capable of covering the space surrounded by the side faces 20a, 20b, 20c, 20d may also be attached.

In the gas generator 10, the housing is formed by a module case, and hence the number of components can be reduced in comparison with a conventional case in which the gas generator and air bag are housed in a module case.

Further, in the gas generator 10, the sectional form of the combustion chamber 40 in the width direction thereof is elliptical, and therefore, in comparison with a case in which a gas generator having a circular cross section in the width direction is housed in a module case, reductions can be achieved in the overall thickness and volume. As a result, an operation to dispose the gas generator 10 in the limited disposal space of an automobile is performed easily.

Next, referring to FIGS. 1 to 4, an operation of the gas generator 10 when incorporated into an air bag system of an automobile will be described. When the automobile receives an impact upon collision, an activation signal is received from a control unit. As a result, the igniter 42 is activated to ignite such that the gas generating agent 44 is ignited and burned, thereby generating gas.

The generated gas causes the internal pressure of the combustion chamber housing 41 to rise, creating an opening in the combustion chamber housing 41 through which the gas is emitted. The emitted gas is discharged through the gas discharge ports 23 to inflate the air bag.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator, comprising a module case forming a housing having a gas discharge port and a combustion chamber included in the module, the combustion chamber accommodating an igniter and a gas generating agent inside a combustion chamber housing, an opening being generated in the combustion chamber housing to discharge gas when the gas generating agent is ignited and burnt to generate gas by activation of the igniter.

2. The gas generator according to claim 1, wherein a cross section of the combustion chamber housing in a width direction thereof is elliptical.

3. The gas generator according to claim 1, wherein the module case can be divided into two parts, and only one of the two divided parts has the gas discharge port.

4. The gas generator according to claim 2, wherein the module case can be divided into two parts, and only one of the two divided parts has the gas discharge port.
